(19) United States
(12) Patent Application Publication
(10) Pub. No.: US 2006/0020959 A1
(43) Pub. Date: Jan. 26, 2006

(54) Apparatus and method of video decoding and outputting

(76) Inventor: Yasuo Masuda, Hirakata-shi (JP)

Correspondence Address: LAWRENCE E. ASHERY;ONE WESTLAKES, BERWYN, SUITE 301, P.O. BOX 980, VALLEY FORGE, PA, 19482-0980, US

(21) Appl. No.: 10/901,613

(22) Filed: Jul. 28, 2004

(30) Foreign Application Priority Data
Jul. 21, 2004 (JP) 2004-212717

(51) Int. Cl. H04N 7/16; H04N 7/173; H04N 11/00; H04N 7/00

(52) U.S. Cl. 725/25; 725/28; 725/131; 725/100; 725/136; 348/468

(57) ABSTRACT

A video decoding and outputting apparatus includes: (a) a receiving means for receiving a digital broadcast; (b) a restoring means for restoring video data and information related to the video data from the digital broadcast received by the receiving means; (c) a viewing restriction information extracting means for extracting viewing restriction information from the related information restored by the restoring means; (d) a video converting means for converting the video data restored by the restoring means into an analog video signal; and (e) an outputting means for inserting the viewing restriction information extracted by the viewing restriction information extracting means into the analog video signal converted by the video converting means, for output.

### BACKGROUND OF THE INVENTION

1. Field of the Invention

The present invention relates to an apparatus and method of video decoding and outputting in which parental information for viewing restriction is inserted into analog video signals.

2. Background Art

Conventionally well known is video decoding and outputting apparatus for inserting closed caption (CC) information in a vertical blanking interval (VBI) of analog video signals, for output. For example, as the reference of a related prior art, specifications of U.S. Pat. No. 5,438,370 are known.

FIG. 11 shows a digital broadcasting receiver, as a conventional video decoding and outputting apparatus. With reference to FIG. 11, digital broadcasting radio waves received by tuner 11 are demodulated into transport streams. The transport streams are restored to audio packets, video packets, and information data by TS decoder 12. The audio packets are restored to audio data by audio decoder 13. The video packets are restored to video data by video decoder 14. Further, these data are converted into audio signals and video signals by audio video output part 15, and thus the audio and video of a received program are supplied through a speaker and monitor. The information data from TS decoder 12 are fed into service information processing part 991. Service information processing part 991 generates electronic program guide (EPG) data for displaying a program list from information data including information on service. EPG data are supplied to multiplexer (MUX) 22, and combined with video data, responsive to an instruction from controller 19 realized by microcomputer or other components and so on. The CC information is included in the video data, and combined with video data in MUX 22. Thus, users can view a program list and closed caption together with the program, responsive to their instruction via user input part 18, for example. The video data supplied from MUX 22 are supplied to National Television System Committee (NTSC) encoder 31. NTSC encoder 31 converts these video data into NTSC composite signals, i.e. analog video signals, for output. Further, into these NTSC composite signals, VBI inserter 32 inserts the CC information from video decoder 14 in a vertical blanking interval. Such NTSC composite signals with the CC information inserted therein are supplied from the conventional video decoding and outputting apparatus.

These analog NTSC composite signals are viewed by being connected to a monitor, or stored in recording equipment, e.g. a video cassette recorder (VCR) or DVD recorder and then viewed through a monitor afterwards.

However, in the conventional video decoding and outputting apparatus, only the CC information is inserted in a VBI of analog video, and parental information for viewing restriction, which is called V-CHIP, is not inserted therein. For this reason, when a program is stored in recording equipment, e.g. a VCR and DVD recorder, and viewed afterwards, the parent of an audience cannot place viewing restriction even if the video is harmful to minors, and a children audience may view a harmful video. In other words, when video signals supplied from an analog composite video output terminal or the like of such a conventional digital broadcasting receiver are viewed, the viewing restriction does not work effectively.

### SUMMARY OF THE INVENTION

The present invention aims to provide an apparatus and method of video decoding and outputting in which viewing restriction works effectively even when video signals supplied from an analog composite video output terminal or the like of a digital broadcasting receiver or the like are viewed or recorded.

To address this problem, a video decoding and outputting apparatus of the present invention includes: (a) a receiving means for receiving a digital broadcast, (b) a restoring means for restoring video data and information related to the video data from the digital broadcast received by the receiving means, (c) a viewing restriction information extracting means for extracting viewing restriction information from the related information restored by the restoring means, (d) video converting means for converting the video data restored by the restoring means into analog video signals, and (e) an outputting means for inserting the viewing restriction information extracted from the viewing restriction information extracting means into analog video signals converted by the video converting means, for output.

A video decoding and outputting method of the present invention converts video data restored from a received digital broadcast into analog composite video signals, for output. The method includes the steps of: (a) converting video data into analog composite video signals, (b) restoring an event information table (EIT) or a program map table (PMT) included in a transport stream in the digital broadcast, (c) extracting content_advisory_descriptor included in the EIT or the PMT, (d) extracting viewing restriction information included in the content_advisory_descriptor, (e) converting the viewing restriction information into viewing restriction information compliant with a video standard of analog video signals, and (f) inserting the converted viewing restriction information in a vertical blanking interval of the analog composite video signals, for output.

### BRIEF DESCRIPTION OF THE DRAWINGS

FIG. 1 is a block diagram illustrating an example of a structure of a video decoding and outputting apparatus in accordance with a first exemplary embodiment of the present invention.

FIG. 2 is a diagram illustrating a structure of a digital broadcasting system in accordance with the first exemplary embodiment of the present invention.

FIG. 3 is a diagram illustrating each signals in a digital broadcast.

FIG. 4 is a drawing showing a structure of content_advisory_descriptor in a digital broadcast.

FIGS. 5a and 5b are tables showing details of data related to parental information in extended data service (XDS).

FIGS. 6a and 6b are tables showing further details in XDS.

FIG. 7 is a flowchart showing parental output processing in the first exemplary embodiment of the present invention.

FIG. 8 is a drawing showing a specific example of parental processing in the first exemplary embodiment of the present invention.

FIG. 9 is a block diagram illustrating an example of a structure of a video decoding and outputting apparatus in accordance with a second exemplary embodiment of the present invention.

FIG. 10 is a diagram illustrating a structure of a digital broadcasting system in accordance with the second exemplary embodiment of the present invention.

FIG. 11 is a drawing illustrating a structure of a conventional digital broadcasting receiver.

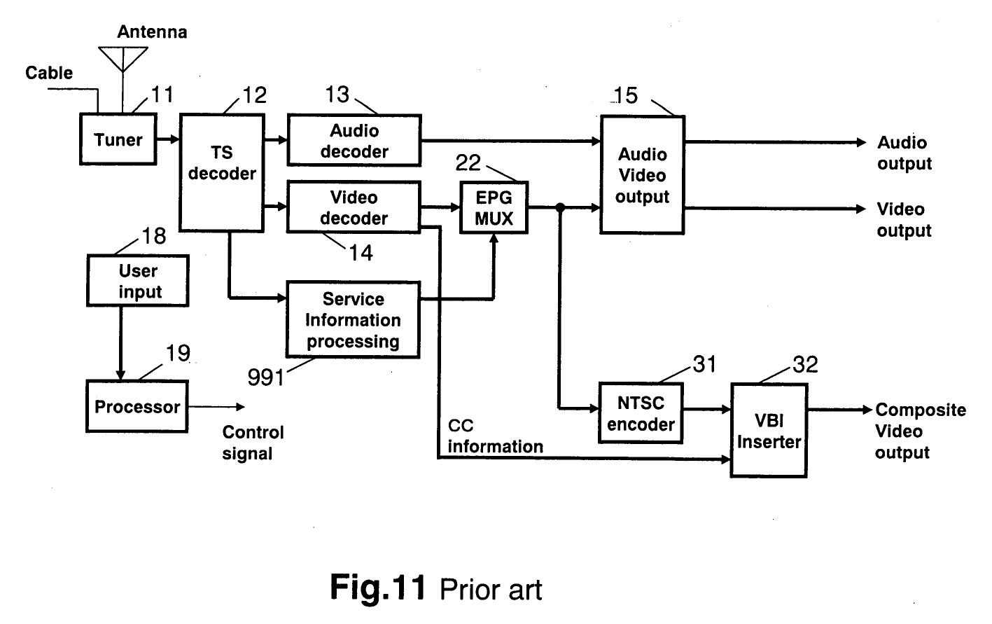

### DETAILED DESCRIPTION OF THE INVENTION

Exemplary embodiments of an apparatus and method of video decoding and outputting of the present invention are detailed hereinafter with reference to the accompanying drawings.

### First Exemplary Embodiment

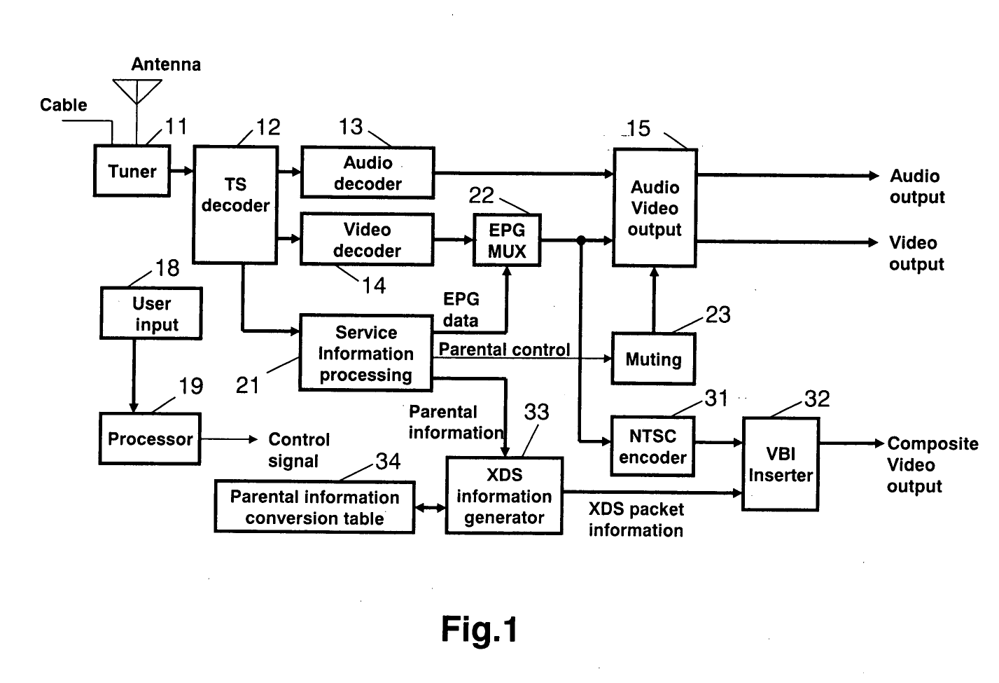

FIG. 1 is a block diagram illustrating the structure of a video decoding and outputting apparatus in accordance with a first exemplary embodiment of the present invention. A description is provided of an example of a digital broadcasting receiver, i.e. an embodiment of a video decoding and outputting apparatus of the present invention.

With reference to FIG. 1, tuner 11 performs demodulation, error correction, or the like on digital broadcasting radio waves received through an antenna or cable. Further, tuner 11 outputs transport streams, i.e. bit streams which consist of packets including various data in digital broadcasting. Tuner 11 is also instructed to receive an intended broadcast by controller 19. Tuner 11 constitutes a receiving means.

Controller 19 is realized microcomputer, for example. Responsive to instruction information from user input part 18 for inputting instruction from user via a remote controller or the like, controller 19 controls tuner 11 to select a station, and also controls other respective components described later and performs processing for the control.

The transport streams from tuner 11 are supplied to transport stream decoder (hereinafter referred to as a TS decoder) 12. TS decoder 12 extracts data of an intended program by packet from these transport streams, separates the data into video packets, audio packets, and information data related to the received broadcast and outputs them. The video packets, audio packets, and information data are supplied to video decoder 14, audio decoder 13, and service information processing part 21 as hereinafter described, respectively. TS decoder 12, video decoder 14, and audio decoder 13 constitute a restoring means.

Video decoder 14 extracts encoded video data compressed according to the motion pictures expert group (MPEG)-2 system from the supplied video packets. Further, video decoder 14 expands the extracted encoded video data, and restores the video data. Thus, video decoder 14 performs video decoding. Then, the restored video data are fed into audio video output part 15 via EPG multiplexer (MUX) 22, which is described later.

Audio decoder 13 decodes the supplied audio packets, and thus the audio data are restored. The restored audio data are also fed into audio video output part 15.

Audio video output part 15 converts the video data supplied from EPG MUX 22 into video signals capable of being displayed on a monitor or the like, and drives a monitor inside or outside of the digital broadcasting receiver. Further, audio video output part 15 converts audio data supplied from audio decoder 13 into audio signals capable of being supplied to a speaker or the like, and drives a speaker inside or outside of a digital broadcasting receiver. Thus, the contents, e.g. video and audio, of the intended program are presented from a monitor and speaker, and a user can view desired contents. The monitor and speaker can be in the form of a television receiver integral with a digital broadcasting receiver. A set top box (STB) that is not integral with a monitor and speaker and externally connected thereto can be used. Alternatively can be used are a VCR or DVD device that are not integral with a monitor and speaker and are mainly for recording and reproducing the program.

On the other hand, the information data separated and extracted by TS decoder 12 is supplied to service information processing part 21 as described above. The information data includes information related to a program and reception thereof. The digital broadcasting receiver of this embodiment receives a program, provides service information of the program, or performs other operations, using this information. This service information includes the channel number of each program, the time when the program starts and ends, the title and genre of the program, and further includes CC information, parental information for viewing restriction, and other information as information related to video data. Service information processing part 21 extracts service information data from the information data separated by TS decoder 12, and stores them in a memory (not shown) or the like for control.

Additionally, service information processing part 21 generates electronic program guide (EPG) data for displaying a program list from this information stored in the memory (not shown) or the like, and feeds the data to EPG MUX 22. Responsive to the instruction of displaying the program list from controller 19, EPG MUX 22 switches from the video data from video decoder 14 to the supplied EPG data or combines them, and outputs them to audio video output part 15. Thus, a user can view a desired program list.

Further, service information processing part 21 exerts parental control, i.e. processing concerning viewing restriction, using parental information included in the service information from TS decoder 12. The parental information is called “V-CHIP” in the United States. This is used to allow authorized users, e.g. parents, to individually block programs undesirable for their children to view. In the digital broadcasting, such parental information is stored in a program map table (PMT) having packet identifiers or the like stored therein, or an event information table (EIT) having service information or the like stored therein in the form of descriptors called “content_advisory_descriptor”. Content_advisory_descriptor” also includes rating information which specifies respective levels of viewing restrictions, e.g. the ages for viewing restrictions. Specifically, respective programs are divided into a group of programs which can be viewed irrespective of age, a group of programs which can be viewed by audiences of at least 13 years old, and so on.

A digital broadcasting receiver generally performs the following operations according to such parental information. When a user selects a desired program, the digital broadcasting receiver recognizes the parental information related to the program, and determines if the program is subject to viewing restriction or not. If the program is subject to viewing restriction, the digital broadcasting receiver requests the user to input a password or the like. When the digital broadcasting receiver can verify the password, it lifts the viewing restriction. Thus, the user can view the selected program as an authorized user. In contrast, a user who does not have the password cannot lift the viewing restriction, and cannot view the program. In this manner, a digital broadcasting receiver selects the user of the program subject to viewing restriction. Thus, parental control is performed.

To perform processing related to such parental control, first, service information processing part 21 determines if a program a user have instructed to present is subject to viewing restriction or not, and informs controller 19 of the determination results. Based on the results, controller 19 requests the user to input a password or the like, when the program is subject to viewing restriction. Controller 19 performs such processing, and informs service information processing part 21 of viewing restriction information, i.e. if the viewing restriction is placed or not. Responsive to the viewing restriction information from controller 19, service information processing part 21 generates parental control signal and controls muting part 23 by generated parental control signal. Muting part 23 controls audio video output part 15 so that it should output video signals and audio signals or not. In other words, when service information processing part 21 instructs muting part 23 to place viewing restriction, muting part 23 controls audio video output part 15 so that it stops output of video signals and audio signals. In this manner, parental control, in which when a program subject to viewing restriction is received, presentation of the program is selectively controlled by the authority of a user, is realized.

Service information processing part 21 has the above function. In other words, service information processing part 21 works as a viewing restriction information extracting means that extracts viewing restriction information as parental information for controlling the presentation of a program from the related information restored by the restoring means constituted of TS decoder 12 and so on.

Further, the present invention also has a function of converting video data restored from a received digital broadcast into composite video signals compliant with the National Television System Committee (NTSC) system, i.e. a standard system of analog video signals, and outputting these composite video signals outside of the digital broadcasting receiver. In the following description, the present invention outputs NTSC composite video signals. However, the invention can be structured to output composite video signals compliant with other systems, e.g. PAL system and SECAM system. Especially, the present invention outputs composite video signals having various kinds of information including the above parental information inserted therein, in a vertical blanking interval (VBI) of the outputting composite video signals.

Video data supplied from EPG MUX 22 are fed into NTSC encoder 31. NTSC encoder 31 converts the supplied video data into NTSC composite video signals. Further, the converted composite video signals are fed into VBI inserter 32. NTSC encoder 31 works as a video converting means that converts the video data restored by the restoring means into analog video signals.

VBI inserter 32 processes various kinds of information to insert it in the horizontal period in a VBI of the composite video signals supplied from NTSC encoder 31, as packets. As a result, composite video signals having various kinds of information inserted in a VBI is outputted from VBI inserter 32. Then, for example, these composite video signals are coupled to recording equipment outside of the digital broadcasting receiver for analog recording, or coupled to other television receiver or the like for viewing through the other equipment. Incidentally, in this embodiment, VBI inserter 32 inserts extended data service (XDS) packet information supplied from XDS information generator 33, which is described next, in a predetermined horizontal period of a VBI. VBI inserter 32 works as an outputting means that inserts information according to the parental information i.e. viewing restriction information extracted by service information processing part 21, i.e. a viewing restriction information extracting means, into analog video signals supplied from NTSC encoder 31 and outputs them.

Parental information extracted by service information processing part 21 is fed into XDS information generator 33. Based on the supplied parental information, XDS information generator 33 generates parental information corresponding to composite video signals to be outputted from VBI inserter 32, and feeds the generated parental information into VBI inserter 32 as XDS packet information. In other words, XDS information generator 33 has a function of converting the parental information in digital broadcasting into the parental information compliant with the standard system of analog video signals. To realize such a function, the present invention further has parental information conversion table 34 as viewing restriction information conversion table.

Parental information conversion table 34 is a conversion table in which the parental information compliant with the standard of digital broadcasting is correlated with the parental information compliant with the standard system of analog video signals. Parental information conversion table 34 is made of memories or the like. Parental information conversion table 34 correlates respective ratings compliant with the standard of the analog video system with respective ratings compliant with the standard of digital broadcasting and stores the analog ratings as data, for example. Referring to this parental information conversion table 34, XDS information generator 33 generates XDS packet information including parental information compliant with the standard system of analog video signals from the parental information compliant with the standard of digital broadcasting that is supplied from service information processing part 21.

Further, XDS generator 33 and parental information conversion table 34 realize a function of viewing restriction information converting means, in which the parental information i.e. viewing restriction information extracted by service information processing part 21, i.e. a viewing restriction information extracting means, is converted into the parental information i.e. viewing restriction information compliant with the video standard of analog video signals converted by NTSC encoder 31.

Now, as an example of inserting various kinds of information in a VBI to provide various kinds of service in the standard system of analog video signals, extended data service (XDS) begins available in the United States, for example. This XDS is specified by the Electronic Industries Association (EIA)-608, a standard in the United States. A part of this XDS is parental control using XDS data including parental information. Also in the XDS, the above rating data are supplied and used for viewing restriction in an analog television broadcasting receiver, or recording and reproducing equipment for reproducing the recorded analog video signals, such as VCR.

In the XDS, XDS data, i.e. extended data, are inserted on the twenty-first horizontal scanning line, i.e. “line 21”, in the second field of the VBI in NTSC composite video signals. This XDS data including parental information is multiplexed with a program and transmitted in analog television broadcasting, for example.

XDS information generator 33 of this embodiment generates parental information based on such XDS, and VBI inserter 32 inserts the XDS data including parental information generated by XDS information generator 33 on “line 21” in the VBI.

In this embodiment, a digital broadcasting receiver corresponding to such XDS is described. However, the present invention is not limited to such XDS, and can be applied to service related to parental control using a VBI that corresponds to each of standards or countries. Especially, storing information corresponding to a plurality of standards and countries in parental information conversion table 34 can easily support a wide range of service related to parental control.

Hereinafter, a description is provided of operations of a digital broadcasting receiver of this embodiment structured as above.

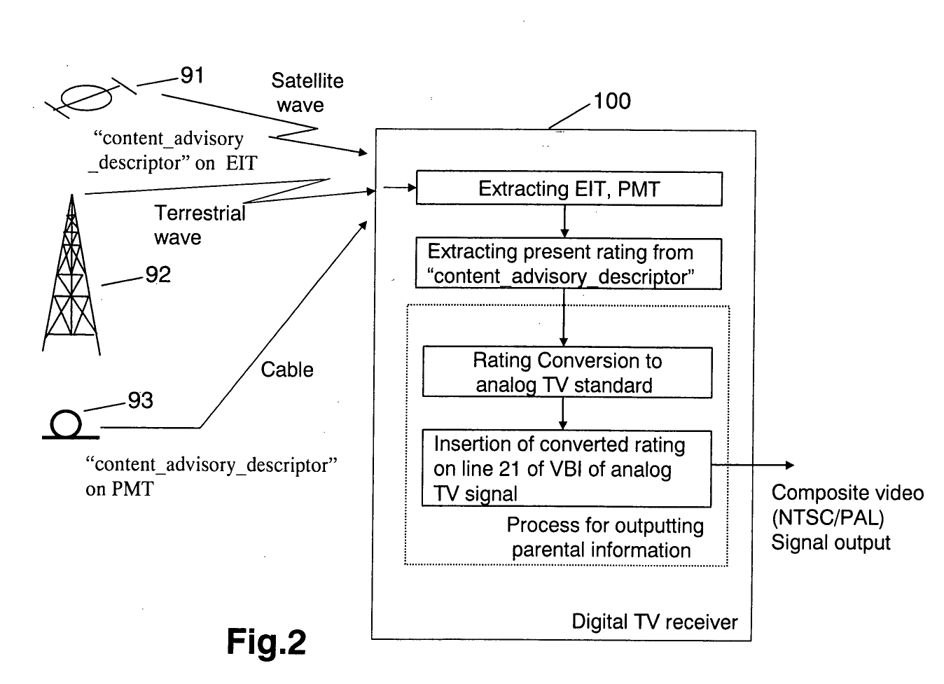

FIG. 2 is a diagram illustrating a structure of a digital broadcasting system including this digital broadcasting receiver. As shown in FIG. 2, digital broadcasting is provided by transmission of satellite waves from broadcasting satellite 91, terrestrial waves from broadcasting transmitter 92, or broadcasting waves from cable transmitter 93 in a cable station. These digital broadcasting radio waves transmitted are received by a digital broadcasting receiver or the like each user has, and each program of the digital broadcasting is presented to the user. FIG. 2 shows an example that this digital broadcasting receiver 100 receives digital broadcasting radio waves. A function peculiar to this digital broadcasting receiver 100 is especially shown as a function block herein. That is a function of converting parental information added to a digital broadcast into parental information compliant with the standard system of analog video signals and inserting the converted parental information into composite video signals for output.

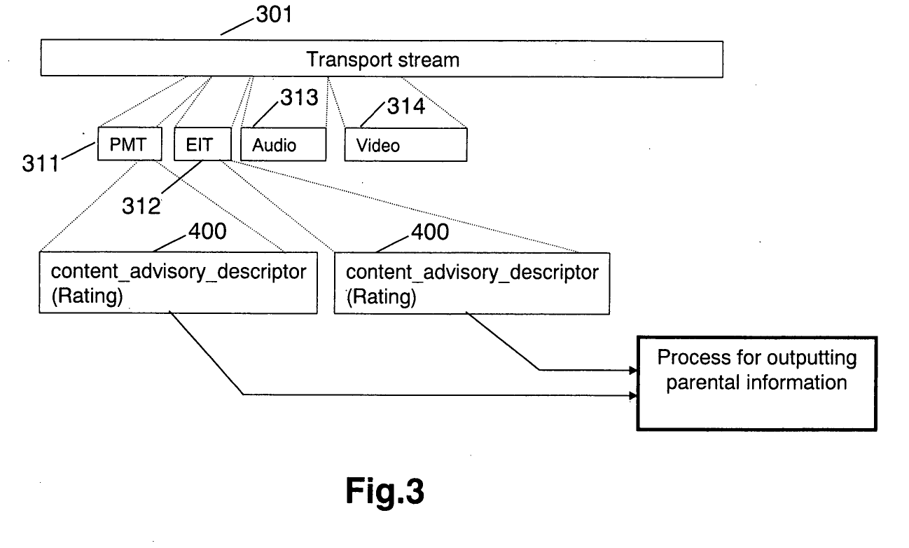

In digital broadcasting system, the parental information is transmitted with being stored in the above EIT or PMT as a descriptor called “content_advisory_descriptor”. FIG. 3 is a diagram showing how each signal is in a digital broadcast. As shown in FIG. 3, in digital broadcasting radio waves, a data series for broadcasting is modulated in the form of a bit stream called a transport stream for transmission. Such digital broadcasting radio waves are restored to transport stream 301 in tuner 11. Transport stream 301 is constituted of a packet series including video packet 314, audio packet 313, PMT packet 311 and EIT packet 312. Further, in PMT packet 311 or EIT packet 312, “content_advisory_descriptor” 400 including rating information is stored. A video decoding and outputting apparatus of the present invention generates XDS packet information based on parental information stored in “content_advisory descriptor” 400, such as rating information, and inserts the XDS packet information in a VBI, for output as composite video signals.

As shown in FIG. 2, first, digital broadcasting receiver 100 extracts an EIT and PMT from transport stream 301. Next, digital broadcasting receiver 100 extracts “content_advisory_descriptor” 400 from the EIT or PMT to extract rating information of the program that is currently being received. Such parental information including the rating information of the received digital broadcast is converted into rating information compliant with the standard of analog video. Further, the converted rating information is inserted on “line 21” in a VBI of analog composite signals, and supplied as NTSC or PAL composite video signals.

Next, a detailed description is provided of the operation of converting parental information in a digital broadcast into parental information compliant with the standard system of analog video signals, which is a feature of this invention.

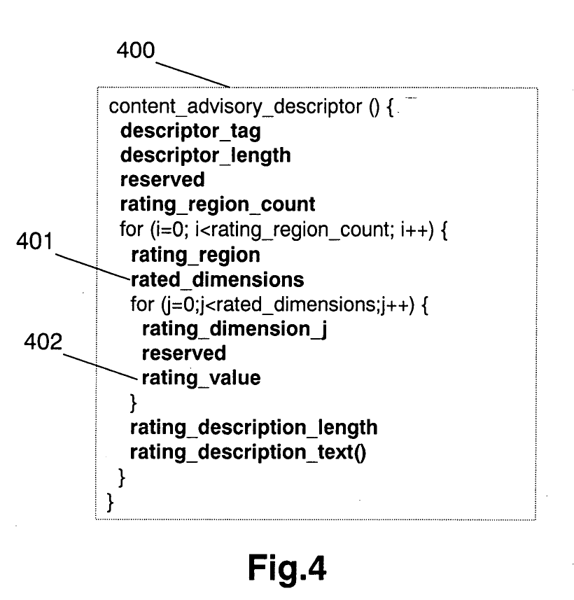

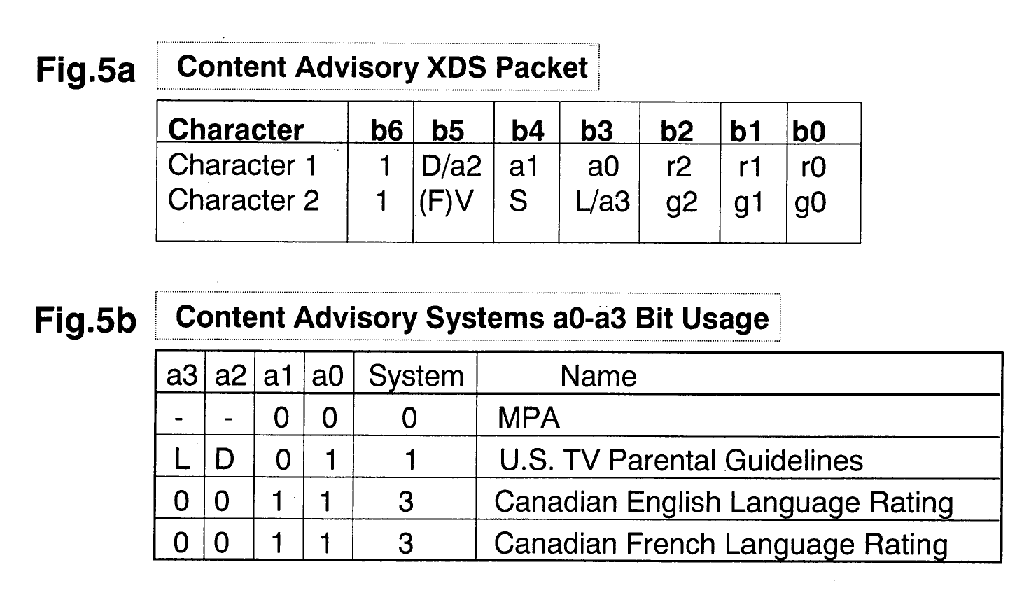

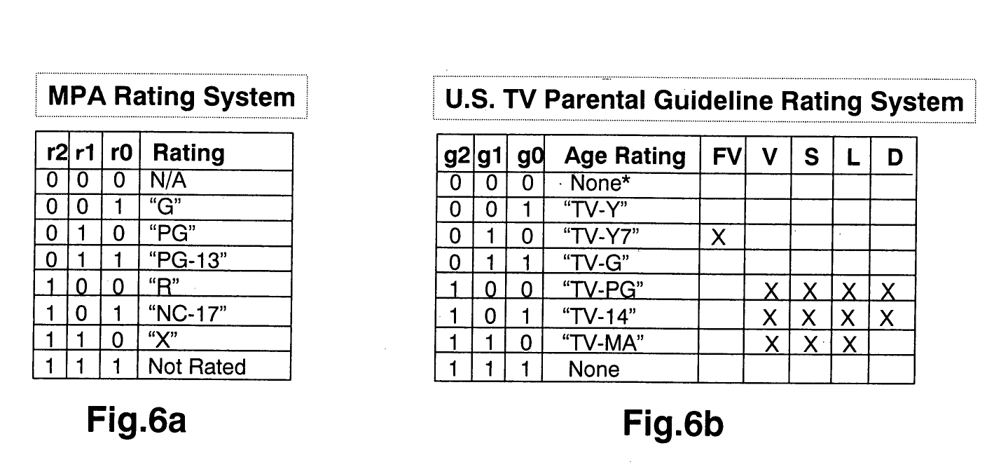

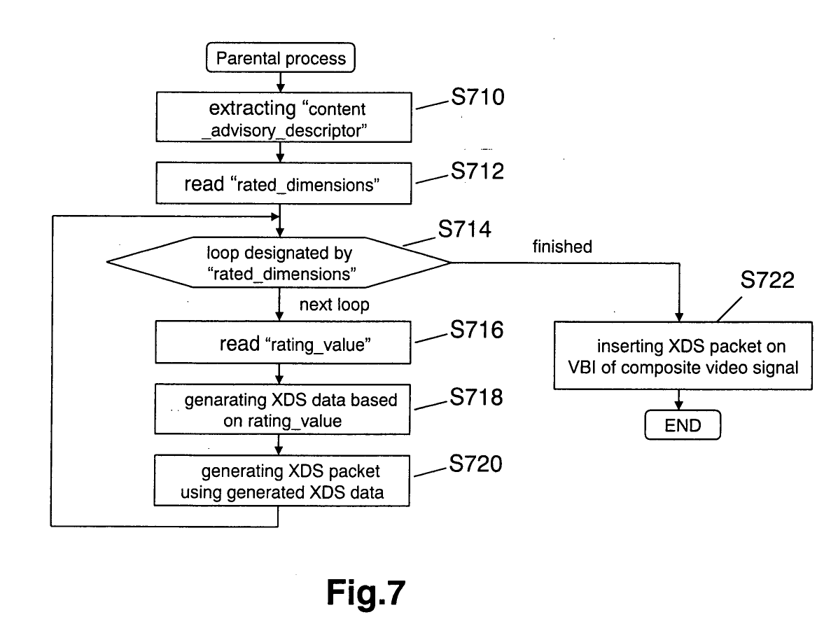

FIG. 4 is a drawing showing a structure of “content_advisory_descriptor” 400 in a digital broadcast. FIGS. 5a and 5b are tables showing details of data related to parental information in XDS. FIGS. 6a and 6b are tables showing further detailed rating information and other information. FIG. 7 is a flowchart showing parental output processing. In other words, FIG. 7 shows from a step of generating XDS packets according to the format of XDS shown in FIG. 5a, 5b and FIG. 6a, 6b based on “content_advisory_descriptor” 400 shown in FIG. 4 to a step of inserting the XDS packets into analog composite video signals.

Hereinafter, a description is mainly provided of the steps of FIG. 7 and of parental output processing of the present invention with reference to FIG. 4 to FIG. 6a, 6b.

In step S710 of FIG. 7, “content_advisory_descriptor” 400 is extracted form an EIT or PMT. In other words, with reference to FIG. 1, service information processing part 21 extracts “content_advisory descriptor” 400 from the supplied EIT or PMT information.

Next, in step S712, “rated_dimensions” 401 is read from “content_advisory_descriptor” 400. In other words, service information processing part 21 analyses extracted “content_advisory_descriptor” 400 and detects this “rated_dimensions” 401 first. “Rated_dimensions” 401 is information indicating the types of viewing restrictions. Such types of viewing restrictions include a viewing restriction compliant with the standard of the Motion Picture Association (MPA), i.e. a film association in the United States, and viewing restrictions compliant with the standards of the U.S. television or Canada television. Further, in some cases, “rated_dimensions” 401 includes a plurality of types of viewing restrictions, e.g. those of MPA and U.S.TV.

Next, in step S714, if the number of loops designated by “rated_dimensions” 401, i.e. the number of types of viewing restrictions applied to the program, has been processed is confirmed. When the designated number of loops has been processed, the procedure goes to step S722. When the designated number of loops has not been processed, the procedure goes to step S716.

In step S716, “rating_value” 402 is read from “content_advisory_descriptor” 400. In other words, service information processing part 21 further analyses “content_advisory_descriptor” 400, and detects this “rating_value” 402. “Rating_value” 402 is information indicating the level of ratings in the type indicated by “rated_dimensions” 401, which has been detected in the previous step.

Next, in step S718, XDS data is generated according to previously detected “rated_dimensions” 401 and “rating_value” 402. In other words, referring to parental information conversion table 34, XDS information generator 33 generates XDS data, i.e. parental information compliant with the standard of analog video signals, from parental information, i.e. “rated_dimensions” 401 and “rating_value” 402, compliant with the standard of digital broadcasting that is supplied from service information processing part 21. Thus, XDS data is generated.

Next, in step S720, an XDS packet is generated using the generated XDS data. In other words, XDS information generator 33 edits the XDS data generated in step S718 into a format corresponding to the XDS packet shown in FIG. 5a, 5b, and generates XDS packet information to be inserted into composite video signals.

As described above, in steps from S716 to S720, XDS packet information corresponding to one type of viewing restriction is generated. After step S720, the procedure returns to step S714. Such processing in steps from S716 to S720 is repeated at the number of times designated by “rated_dimensions” 401.

Further, in step S722, the XDS packet information generated in step S720 is inserted in a VBI of composite video signals. In other words, VBI inserter 32 inserts the XDS packet information from XDS information generator 33 on “line 21” in the VBI.

As described above, performing processing in the steps shown FIG. 7 realizes a video decoding and outputting method in a video decoding and outputting apparatus of the present invention.

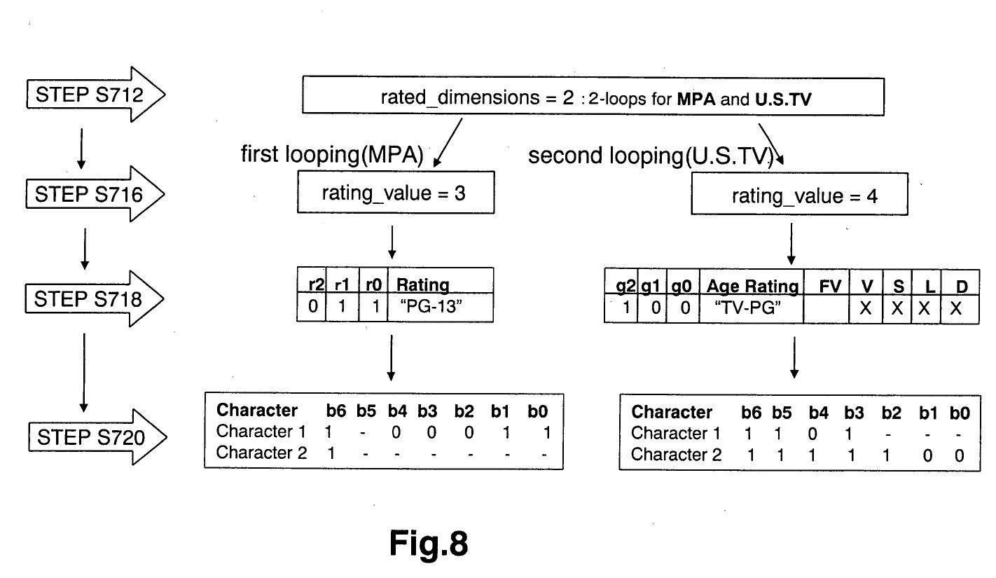

FIG. 8 is a drawing showing a specific example of the parental processing described with reference to FIG. 7. FIG. 8 shows a specific example, corresponding to respective steps of FIG. 7. For simple description, FIG. 8 gives an example in which the MPA rating is “PG-13” and the U.S. TV rating is “TV-PG”.

First, as shown in step S710 of FIG. 7, this digital broadcasting receiver extracts “content_advisory_descriptor” 400 from PMT 311 or EIT 312 in transport stream 301 of FIG. 3.

Next, as shown in step S712 of FIG. 8, referring to “rated_dimensions” 401 in “content_advisory descriptor” 400, the digital broadcasting receiver determines the types of viewing restrictions in the transport stream. In this example, “rated_dimensions” 401 is “2”. This shows two types of viewing restrictions, i.e. MPA and U.S. TV, are used. Further, because two types are used, it is determined that two loops are necessary.

In the first loop, the parental information of MPA is obtained. FIG. 8 shows an example in which “rating_value” 402 of MPA is “3”. In this case, referring to parental information conversion table 34 including information shown in FIG. 6a, XDS information generator 33 determines that the rating is “PG-13”. Further, referring to the format of XDS packets shown in FIG. 5a, 5b, XDS information generator 33 determines that both “a1” and “a0” are “0” for MPA, and “r2” is “0”, “r1” is “1” and “r0” is “1” for “PG-13”.

Next, in the second loop, the parental information of U.S. TV is obtained. FIG. 8 shows an example in which “rating_value” 402 of U.S. TV is “4”. In this case, referring to parental information conversion table 34 including information shown in FIG. 6b, XDS information generator 33 determines that the rating is “TV-PG”. Further, referring to the format of XDS packets shown in FIG. 5b, XDS information generator 33 determines that “a1” is “0” and “a0” is “1” for U.S. TV, and all of “V”, “S”, “L” and “D” are “1” for “TV-PG”.

In this manner, XDS packets shown in step S720 of FIG. 8 are generated. When a plurality of types of viewing restrictions is applied like this example, the XDS packets of all the types are inserted in the VBI. However, the priority of viewing restrictions is set beforehand, and the viewing restriction having higher priority can be selected. Alternatively, a user can select the viewing restriction for insertion in the VBI. For viewing restrictions other than described above, e.g. “NC-17”, “X”, and “TV-MA”, the same processing as described above is performed and a description thereof is omitted. Additionally, for information on Canadian viewing restrictions of FIG. 5b, the same processing can be used to insert parental information in an analog VBI.

### Second Exemplary Embodiment

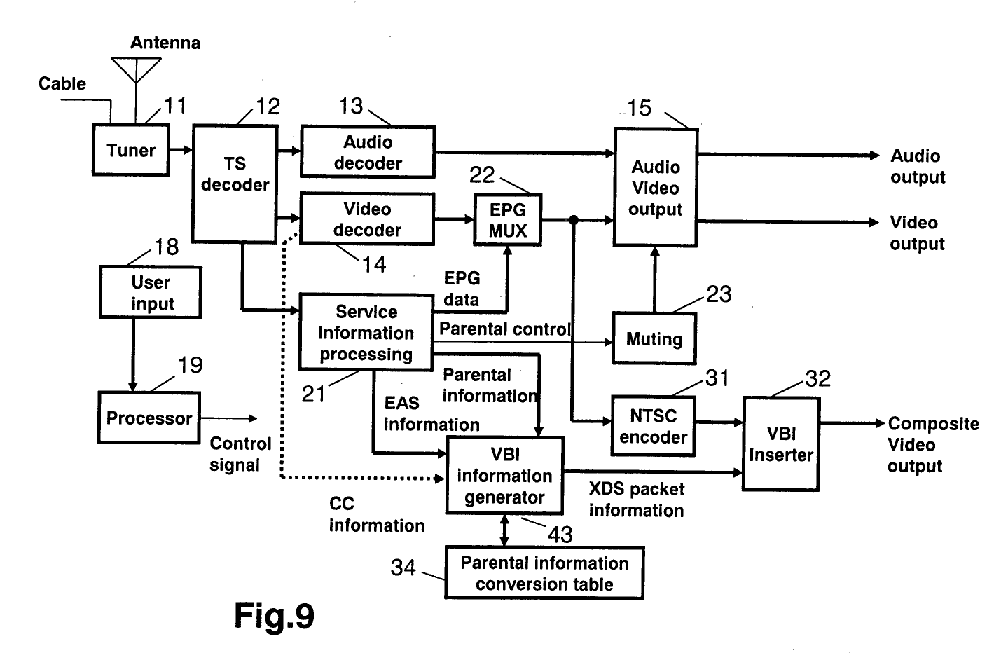

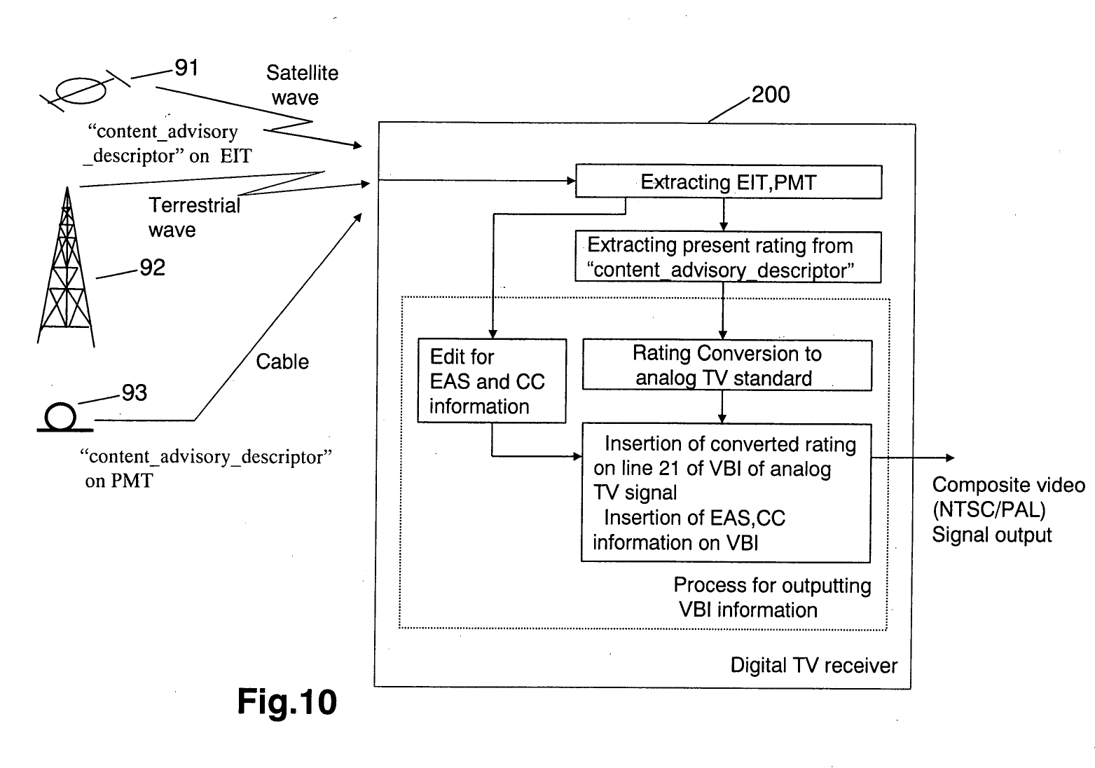

FIG. 9 is a block diagram illustrating a structure of a video decoding and outputting apparatus in accordance with the second exemplary embodiment of the present invention. Also in the second exemplary embodiment, an example of a digital broadcasting receiver, i.e. an embodiment of a video decoding and outputting apparatus of the present invention, is described. The second exemplary embodiment of FIG. 9 is different from the embodiment of FIG. 1 in that the second exemplary embodiment has VBI information generator 43 instead of XDS information generator 33 of FIG. 1. FIG. 10 is a diagram illustrating a structure of a digital broadcasting system including a digital broadcasting receiver of the second exemplary embodiment.

Hereinafter a description is provided of a structure and operation of digital broadcasting receiver 200 of the second exemplary embodiment with reference to FIGS. 9 and 10.

As shown in FIG. 9, VBI information generator 43 receives emergent alert system (EAS) information together with parental information from service information processing part 21, and closed caption (CC) information from video decoder 14. The EAS means service for broadcasting emergency information, such as a tornado, multiplexed into a TV broadcast.

Based on supplied parental information, EAS information, and CC information, VBI information generator 43 generates XDS packet information that includes parental information corresponding to composite video signals to be supplied from VBI inserter 32, and also generates XDS packet information including EAS information and CC information. In other words, as shown in FIG. 10, VBI information generator 43 has a function of editing EAS information and CC information so as to correspond to XDS packets. Further, VBI information generator 43 feeds XDS packets, including generated parental information, EAS information, and CC information, to VBI inserter 32. In turn, VBI inserter 32 inserts respective XDS packets generated by VBI information generator 43 on the line in the VBI. As a result, this digital broadcasting receiver 200 outputs composite video signals having EAS information and CC information together with parental information inserted therein.

This digital broadcasting receiver 200 can insert both of EAS information and CC information together with parental information. Alternatively, the digital broadcasting receiver can insert one of them or combination with other information.

As described above, the present invention can provide an apparatus and method of video decoding and outputting in which viewing restrictions effectively work even when video signals supplied from an analog composite video output terminal or the like are viewed or recorded. Thus, the present invention can apply to equipment having a function of receiving digital video and outputting it as analog video signals, a digital broadcasting receiver, STB, VCR, DVD device, or other apparatuses having such a function.

What is claimed is:

1. A video decoding and outputting apparatus comprising:
(a) a receiving means for receiving a digital broadcast;
(b) a restoring means for restoring video data and information related to the video data from the digital broadcast received by the receiving means;
(c) a viewing restriction information extracting means for extracting viewing restriction information from the related information restored by the restoring means;
(d) a video converting means for converting the video data restored by the restoring means into an analog video signal; and
(e) an outputting means for inserting the viewing restriction information extracted by the viewing restriction information extracting means into the analog video signal converted by the video converting means, for output.

2. The video decoding and outputting apparatus of claim 1, further comprising:
a viewing restriction information converting means for converting the viewing restriction information extracted by the viewing restriction information extracting means into viewing restriction information compliant with a video standard of the analog video signal;
wherein the outputting means inserts the viewing restriction information compliant with the video standard of the analog video signal converted by the viewing restriction information converting means into the analog video signal converted by the video converting means, for output.

3. The video decoding and outputting apparatus of claim 2, further comprising:
a viewing restriction information conversion table having (i) viewing restriction information compliant with a video standard of digital broadcasting and (ii) viewing restriction information compliant with the video standard of the analog video signal stored therein;
wherein the viewing restriction information converting means refers to the viewing restriction information conversion table, and converts the viewing restriction information extracted by the viewing restriction information extracting means into viewing restriction information compliant with the video standard of the analog vide signal converted by the video converting means.

4. The video decoding and outputting apparatus of claim 3, wherein
the restoring means restores the related information from one of an event information table (EIT) and a program map table (PMT) both included in a transport stream of the digital broadcast;
the viewing restriction information extracting means extracts content_advisory_descriptor included in the related information restored by the restoring means; and
the viewing restriction information converting means refers to the viewing restriction information conversion table, and converts viewing restriction information included in the content_advisory descriptor into the viewing restriction information compliant with the video standard of the analog video signal.

5. The video decoding and outputting apparatus of claim 4, wherein the viewing restriction information converting means converts
the viewing restriction information included in the content_advisory_descriptor into viewing restriction information based on extended data service compliant with Electronic Industries Association (EIA)-608 standard.

6. The video decoding and outputting apparatus of claim 2, wherein the outputting means inserts emergent alert system (EAS) information, i.e. emergency information, included in the related information restored by the restoring means together with viewing restriction information compliant with the video standard of the analog vide signal converted by the viewing restriction information converting means into the analog video signal converted by the video converting means, for output.

7. A video decoding and outputting method for converting video data restored from a received digital broadcast into an analog composite video signal for output, the method comprising the steps of:
(a) converting video data into the analog composite video signal;
(b) restoring one of an event information table (EIT) and a program map table (PMT) both included in a transport stream of the digital broadcast;
(c) extracting content_advisory_descriptor included in one of the EIT and PMT;
(d) extracting viewing restriction information included in the content_advisory_descriptor;
(e) converting the viewing restriction information into viewing restriction information compliant with a video standard of the analog video signal; and
(f) inserting the converted viewing restriction information in a vertical blanking interval of the analog composite video signal, for output.

8. The video decoding and outputting method of claim 7, further comprising a step of inserting emergency alert system (EAS) information, i.e. emergency information, included in the transport stream in the vertical blanking interval of the analog composite video signal, for output.
